(19) United States
(12) Patent Application Publication
(10) Pub. No.: US 2018/0272548 A1
(43) Pub. Date: Sep. 27, 2018

(54) SHEARS

(71) Applicant: MILWAUKEE ELECTRIC TOOL CORPORATION, Brookfield, WI (US)

(72) Inventor: Daniel H. Schneider, Franklin, WI (US)

(21) Appl. No.: 15/991,302

(22) Filed: May 29, 2018

Related U.S. Application Data
(63) Continuation of application No. 14/298,223, filed on Jun. 6, 2014, now abandoned.
(60) Provisional application No. 61/832,042, filed on Jun. 6, 2013.

(51) Int. Cl. B26B 13/28; B26B 13/16; B26B 13/26; B23D 29/02

(52) U.S. Cl. CPC B26B 13/28; B26B 13/16; B23D 29/026; B26B 13/26

(57) ABSTRACT

A shears that includes a first cutting blade including a first aperture and a second cutting blade including a second aperture, the second cutting blade pivotally coupled to the first cutting blade at a pivot joint. The shears further includes a first handle operable to pivot the first cutting blade about the pivot joint and a second handle operable to pivot the second cutting blade about the pivot joint. The pivot joint includes a bolt that extends through the first aperture and the second aperture. The bolt includes a head, a shank that extends from the head, and a longitudinal axis that extends centrally through the head and the shank along a length of the shank. The head includes a concave outer surface that extends around the longitudinal axis of the bolt.

### CROSS-REFERENCE TO RELATED APPLICATIONS

This application is a continuation of U.S. patent application Ser. No. 14/298,223, filed Jun. 6, 2014, which claims priority to U.S. Provisional Patent Application No. 61/832,042, filed Jun. 6, 2013, the entire contents of which are hereby incorporated by reference herein.

### BACKGROUND

The present invention relates to a shears.

Shears typically include blades that are pivotally coupled. The blades are pivoted by handles and the shears are used to cut work-pieces, such as paper, cardboard, foil, cloth, rope, sheet metal, etc. The blades are pivotally coupled at a pivot joint. The pivot joint may be formed by a bolt and a nut. The nut and the bolt extend from sides of the blades and can snag or catch on a user's pocket, tool belt, tool pouch, or the like when the user puts the shears into their pocket, belt, or pouch.

### SUMMARY

In one embodiment, the invention provides a shears that includes a first cutting blade including a first aperture, and a second cutting blade including a second aperture, the second cutting blade pivotally coupled to the first cutting blade at a pivot joint. The shears further includes a first handle operable to pivot the first cutting blade about the pivot joint and a second handle operable to pivot the second cutting blade about the pivot joint. The pivot joint includes a bolt that extends through the first aperture and the second aperture. The bolt includes a head, a shank that extends from the head, and a longitudinal axis that extends centrally through the head and the shank along a length of the shank. The head includes a concave outer surface that extends around the longitudinal axis of the bolt.

Other aspects of the invention will become apparent by consideration of the detailed description and accompanying drawings.

### BRIEF DESCRIPTION OF THE DRAWINGS

FIG. 1 is a perspective view of a shears according to an embodiment of the invention.

FIG. 2 is an alternative perspective view of the shears of FIG. 1.

FIG. 3 is a top view of a portion of the shears of FIG. 1.

FIG. 4 is a cross-sectional view taken along lines 4-4 of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

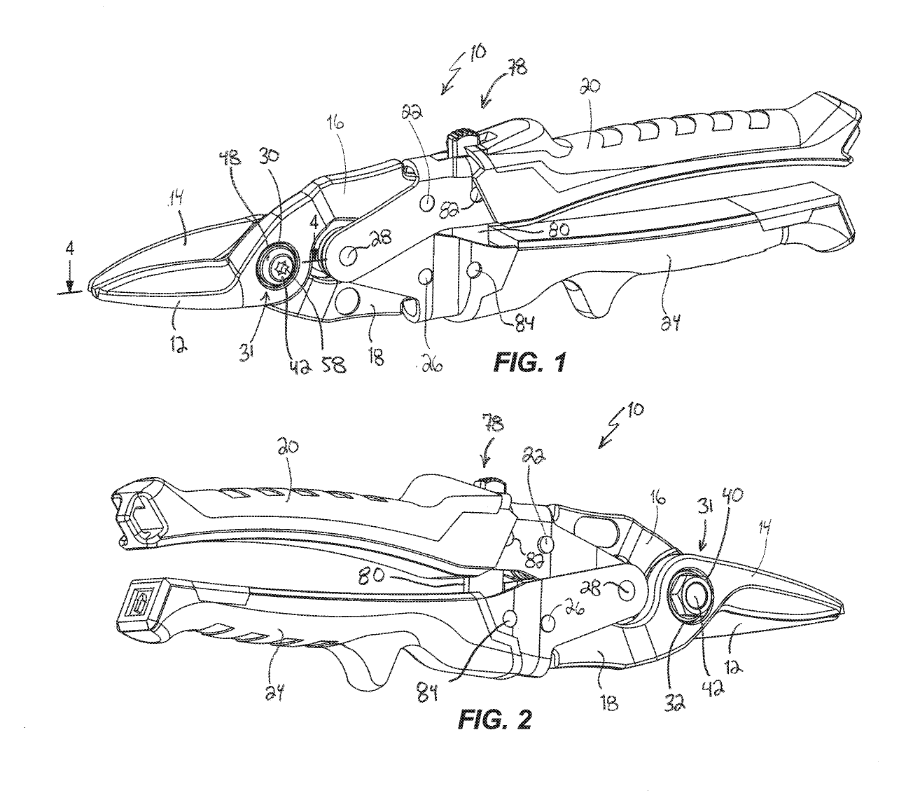

FIGS. 1-2 illustrate a shears 10, which is a snips in the illustrated embodiment. In other embodiments, the shears can include other types of shears such as wire cutters, bolt cutters, scissors, crimpers, and others.

The snips 10 includes a first cutting blade 12 and a second cutting blade 14. The first blade 12 includes a first extension portion 16. The second blade 14 includes a second extension portion 18. The first extension portion 16 is pivotally coupled to a first handle 20 about a first handle pivot joint 22. The second extension portion 18 is pivotally coupled to a second handle 24 about a second handle pivot joint 26. The first handle 20 and the second handle 24 are pivotally coupled to each other about a central pivot joint 28. In the illustrated construction, the pivot joints 22, 26, 28 include rivets.

Referring to FIG. 4, the first cutting blade 12 includes an aperture 30 that extends through the extension portion 16 and the second cutting blade 14 includes an aperture 32 that extends through the extension portion 18. The aperture 30 includes a countersunk portion 34 and the aperture 32 includes a countersunk portion 36.

Referring to FIGS. 1 and 4, the first blade 12 and the second blade 14 pivot with respect to each other about a blade pivot joint 31 between a closed position and an open position to cut a work-piece. The pivot joint 31 includes a nut 40, a bolt 42, a first washer 44, and a second washer 46.

The bolt 42 includes a head 48, a shank 50 that extends from the head 48, and a longitudinal axis 52 that extends centrally through the head 48 and the shank 50 along a length of the shank 50. The shank 50 includes a threaded portion 54. The nut 40 engages the threaded portion 54 to couple the nut 40 and the bolt 42 to the cutting blades 12, 14. In one embodiment, the nut 40 is a locknut, which inhibits the nut 40 from loosening or rotating relative to the bolt 42 during use of the snips 10. The nut 40 has the thread formed with up sets on the threads to help them bind onto the threaded portion 54 of the bolt 42.

The head 48 includes a flat portion 56 that is perpendicular to the axis 52. A recess 58 is located in the flat portion 56. The recess 58 receives a driver, such as a screwdriver, that can be used to tighten the bolt 42 and the nut 40 so that the blades 12, 14 open and close with a desired resistance. The first washer 44 is located in the first countersunk portion 34 between the head 48 and the cutting blade 12. The second washer 46 is located in the second countersunk portion 36 between the nut 40 and the cutting blade 14. In one embodiment, the washers 44, 46 are spring washers. The washers 44, 46 maintain pressure on the nut 40 and the bolt 42 so that the nut 40 and bolt 42 generally do not rotate relative to each other when the blades 12, 14 open and close. Therefore, the washers 44, 46 maintain the desired opening and closing resistance of the blades 12, 14 after repeated use (i.e., opening and closing of the blades 12, 14) of the snip 10.

The head 48 further includes an outermost periphery 60 that surrounds the axis 52. The periphery 60 is sized so that the head 48 is received in the countersunk portion 34 of the aperture 30. The head 48 further includes a concave outer surface 62 that extends around the axis 52 of the bolt 42. The concave outer surface 62 extends around the periphery of the flat portion 56 and extends from the outer periphery 60 of the head 48 to the flat portion 56. The concave outer surface 62 is generally located outside the countersunk portion 34 of the aperture 30. In other embodiments, a portion of the concave outer surface 62 can be located within the countersunk portion 34.

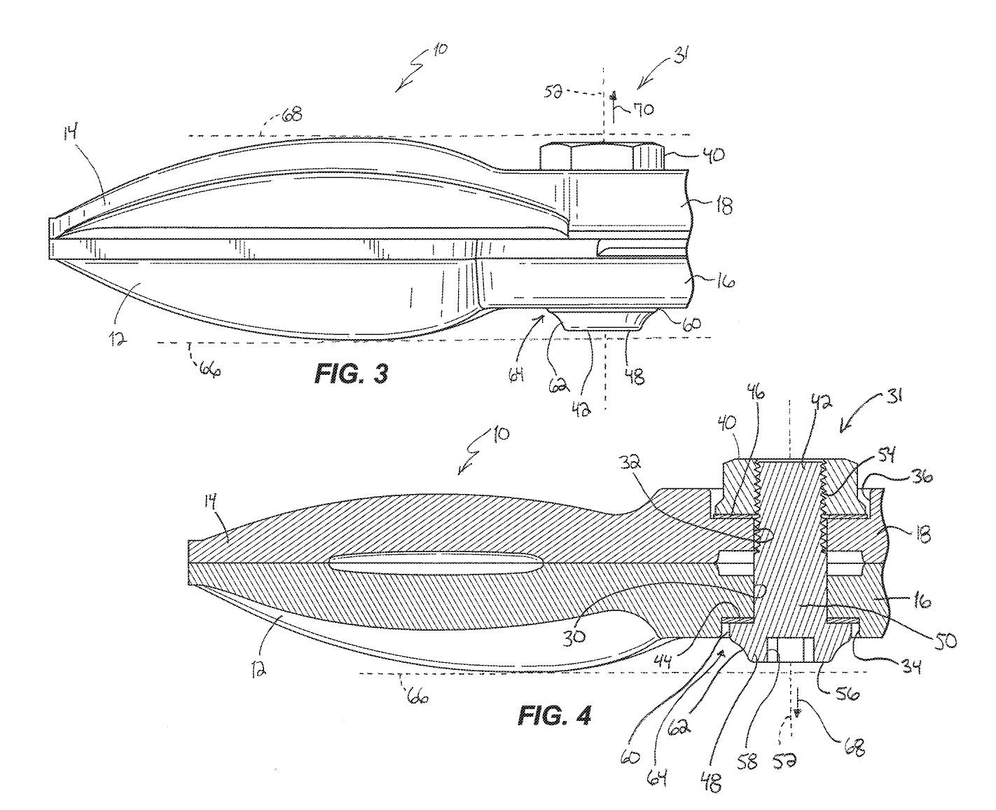

The blade pivot joint 31 has a relatively low profile relative to the blades 12, 14 so that the snips 10 can be easily inserted into a user's tool carrying device (e.g., pocket, tool belt, tool pouch, etc.) with very minimal risk of snagging or catching on the user's tool carrying device. The concave outer surface 62 provides a smooth transition region 64 between the blade 12 and the bolt 42 that inhibits the bolt 42 from snagging or catching on a user's tool carrying device when the snips 10 is inserted into a user's tool carrying device. In addition, as illustrated by axis 66 in FIG. 4 that is tangent to the blade 12 and perpendicular to the axis 52, no portion of the head 48 extends beyond the blade 12 measured along the axis 52 in the direction of arrow 68 from the blade 14 toward the blade 12. Also, the nut 40 is partially located within the countersunk portion 36 of the aperture 32, which also minimizes the profile of the pivot joint 31. As illustrated by axis 68 in FIG. 3 that is tangent to the blade 14 and perpendicular to the axis 52, no portion of the nut 40 extends beyond the blade 14 measured along the axis 52 in the direction of arrow 70 from the blade 12 toward the blade 14.

Referring back to FIGS. 1 and 2, the snips 10 includes a pivoting lock assembly 78. The lock assembly 78 retains the handles 20, 24 in a closed position, as illustrated in FIG. 1. The lock assembly 78 inhibits the handles 20, 24 and the blades 12, 14 from moving toward an open position because the blades 12, 14 are spring biased toward the open position. The lock assembly 78 includes a latch member 80 pivotally coupled to the first handle 20 about a latch pivot 82, which is a rivet in the illustrated construction. The latch member 80 defines a latch hook that engages a latch pin 84 coupled to the second handle 24 to retain the snips 10 in the closed position. The latch pin 84 is also a rivet in the illustrated construction. The rivets 82, 84 and the rivets 22, 26, 28 also provide a relatively low provide of the snips 10 that allows the snips 10 to be easily inserted into a user's tool carrying device with very minimal risk of snagging or catching on the user's tool carrying device.

Various features and advantages of the invention are set forth in the following claims.

What is claimed is:

1. A shears comprising:
a first cutting blade including a first aperture;
a second cutting blade including a second aperture, the second cutting blade pivotally coupled to the first cutting blade at a pivot joint;
a first handle operable to pivot the first cutting blade about the pivot joint; and
a second handle operable to pivot the second cutting blade about the pivot joint,
wherein the pivot joint includes a bolt that extends through the first aperture and the second aperture, the bolt including a head, a shank that extends from the head, and a longitudinal axis that extends centrally through the head and the shank along a length of the shank, and
wherein the head includes a concave outer surface that extends around the longitudinal axis of the bolt.

2. The shears of claim 1, wherein the concave outer surface is located at least partially outside the first and second apertures.

3. The shears of claim 2, wherein the first aperture includes a countersunk portion, and wherein the head is at least partially located within the countersunk portion.

4. The shears of claim 3, wherein the concave outer surface is located at least partially outside the countersunk portion.

5. The shears of claim 1, wherein the pivot joint further includes a nut, and wherein the shank includes a threaded portion engaged with the nut.

6. The shears of claim 5, wherein the head is at least partially located in the first aperture and the nut is at least partially located in the second aperture.

7. The shears of claim 6, wherein the first aperture includes a countersunk portion, wherein the second aperture includes a countersunk portion, and wherein the head is at least partially located in the countersunk portion of the first aperture and the nut is at least partially located in the countersunk portion of the second aperture.

8. The shears of claim 5, further comprising a first washer located in the first aperture between the head and the first blade.

9. The shears of claim 8, further comprising a second washer located in the second aperture between the second blade and the nut.

10. The shears of claim 1, wherein the head includes a recess configured to receive a driver, wherein the concave outer surfaces extends around the recess.

11. The shears of claim 1, wherein the head includes a flat portion perpendicular to the longitudinal axis, and wherein the concave outer surface extends around a periphery of the flat portion.

12. The shears of claim 1, wherein the head includes an outermost periphery located at a furthest distance from the longitudinal axis and surrounding the longitudinal axis, and wherein the concave outer surface extends from the outermost periphery toward the longitudinal axis.

13. The shears of claim 12, wherein the head includes a flat portion perpendicular to the longitudinal axis, wherein the concave outer surface extends from the outermost periphery of the head to the flat portion.

14. The shears of claim 13, wherein the flat portion includes a recess configured to receive a driver.

15. The shears of claim 1, wherein no portion of the head of the bolt extends beyond the first cutting blade measured along the longitudinal axis of the bolt going in a direction from the second blade to the first blade.

16. The shears of claim 15, wherein the pivot joint further includes a nut, wherein the shank includes a threaded portion engaged with the nut, wherein no portion of the nut extends beyond the second cutting blade measured along the longitudinal axis of the bolt going in a direction from the first blade to the second blade.

17. The shears of claim 1, wherein the pivot joint is a first pivot joint, wherein the first handle is pivotally coupled to the first cutting blade at a second pivot joint, wherein the second handle is pivotally coupled to the second cutting blade at a third pivot joint, and wherein the first handle is coupled to the second handle at a fourth pivot joint.

18. The shears of claim 17, wherein the second and third pivot joints include a rivet.
